(19) United States
(12) Patent Application Publication
(10) Pub. No.: US 2010/0057749 A1
(43) Pub. Date: Mar. 4, 2010

(54) METHOD FOR PLAYING E-MAIL

(75) Inventors: Po-Huan Chen, Taipei (TW); Hsin-Yi Li, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/393,043

(22) Filed: Feb. 26, 2009

(30) Foreign Application Priority Data
Sep. 3, 2008 (TW) 97133814

(51) Int. Cl. G06F 17/30; G06F 15/16

(52) U.S. Cl. 707/10; 709/206; 707/E17.01; 707/E17.032

(57) ABSTRACT

A method for playing an E-mail is provided. The E-mail is read in from a mail transmitting and receiving apparatus, and the E-mail includes a number of mail information fields. Further, an assigned filed data is checked, and at least one of the mail information fields is recorded in the assigned filed data. Moreover, according to the mail information field recorded in the assigned filed data, a mail message is extracted from a corresponding mail information field of the E-mail. In addition, the mail message is stored in a text temporary file. Further, the text temporary file is transformed into an audio data file for playing.

### CROSS-REFERENCE TO RELATED APPLICATION

This application claims the priority benefit of Taiwan application serial no. 97133814, filed on Sep. 3, 2008. The entirety of the above-mentioned patent application is hereby incorporated by reference herein and made a part of this specification.

### BACKGROUND OF THE INVENTION

1. Field of the Invention

The present invention relates to a method for operating an E-mail and particularly relates to a method for reading an E-mail via audio.

2. Description of Related Art

Thanks to the development of Internet and information environment, in the busy world more and more people are starting to use electronic media (such as mobile phones, personal digital assistances, or computers) for communication. Among all the electronic media, E-mail is considered as one of the most commonly-used communication method. As electronic-society develops, not only ordinary users, many companies also start using E-mail for communication and transmitting documents. E-mail has become an indispensable communication method in our life, and our requirements and dependence on E-mail are increasing as well.

Conventionally, the users are required to read each E-mail in front of the computers. Reading E-mails for a long time inevitably brings tiredness to the eyes of the users, and the tiredness gets worse when the E-mails have long texts.

Additionally, it is rather inconvenient for users who are disabled or have poor vision to use E-mail. Hiring others to read E-mails aloud however not only increases the costs but also raises the concern about divulging confidential or personal information.

### SUMMARY OF THE INVENTION

Accordingly, the present invention provides a method for playing a text of an E-mail via audio.

The present invention provides a method for playing E-mail. First, an E-mail is read in from a mail transmitting and receiving apparatus, and the E-mail includes a plurality of mail information fields. Next, an assigned filed data is checked, wherein the assigned filed data records at least one of the mail information fields. Afterward, a mail message is extracted from a corresponding mail information field of the E-mail according to the mail information field recorded in the assigned filed data. Next, the extracted mail message is stored in a text temporary file. Finally, the text temporary file is transformed into an audio data file so as to be played via audio.

According to one embodiment of the present invention, the method further includes creating the text temporary file, before storing the extracted mail message in the text temporary file. Herein, the step of creating the text temporary file is to create temporary fields in the text temporary file to respectively correspond to the mail information fields of the E-mail, so as to fill the extracted mail message in the corresponding temporary field in the text temporary file.

According to one embodiment of the present invention, the method further includes judging whether the E-mail in the mail transmitting and receiving apparatus has been read or not, before reading in the E-mail, so as to read in an unread E-mail.

According to one embodiment of the present invention, the method further comprises recording at least one of the mail information fields, which is selected by a user, in the assigned filed data, before extracting the mail message from the corresponding mail information field of the E-mail.

According to one embodiment of the present invention, the method further comprises executing a mail processing operation after the step of playing the audio data file, so as to determine whether to continue playing the audio data file. Herein, the mail processing operation may be one of the following steps, replaying, deleting a mail, reviewing a previous mail, reviewing a following mail, replying a mail, and forwarding a mail. In addition, an audio-control signal may be further received to execute the mail processing operation.

According to one embodiment of the present invention, the mail information fields include at least one of a sender field, a subject field, a receipt date field, a priority field, and a text field.

According to the present invention, the mail message in the mail information field which the user intends to listen to is extracted from the E-mail and stored in the text temporary file. Further, the text temporary file is transformed into the audio data file, so as to play the E-mail via audio. Such a method greatly increases the convenience of using E-mail. Hence, the disadvantage that the user is required to look at the screen for reading each E-mail is overcome, and the user's efficiency at work is improved. Additionally, instead of transforming the whole E-mail, the method of the present invention merely transforms the mail information field recorded in the assigned filed data into the audio data file, and thus reduces the time for transforming word-format text into audio text.

To make the above features and advantages of the present invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart illustrating a method for playing E-mail according to one embodiment of the present invention.

FIG. 2 is a flow chart illustrating a method for playing E-mail according to another embodiment of the present invention.

### DESCRIPTION OF EMBODIMENTS

To make the content of the present invention more comprehensible, embodiments are described below as examples to prove that the invention is actually realizable. In the following embodiments, a method for playing E-mail is, for example, performed by using playback software written based on program language (such as C language, Java language, and so forth). However, the application of the present invention is not limited thereto.

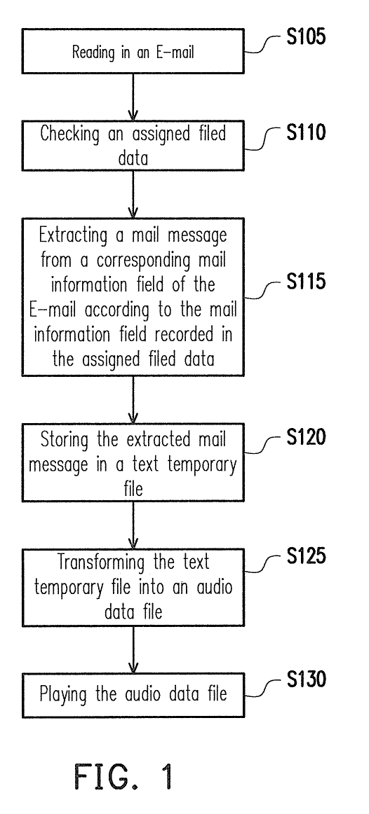

FIG. 1 is a flow chart illustrating a method for playing E-mail according to one embodiment of the present invention. With reference to FIG. 1, in Step S105, the playback software reads in an E-mail from a mail transmitting and receiving apparatus first, and the E-mail comprises a plurality of mail information fields. The mail transmitting and receiving apparatus comprises a web mailbox and an E-mail client software, such as Outlook. The mail information fields comprise a sender field, a subject field, a receipt date field, a priority field, a text field, and so forth.

Generally speaking, the E-mail may be further divided into two parts, a mail heading (comprising the sender field, the subject field, the receipt date field, and the priority field) and the text field. The step of reading in the E-mail is, for example, to read the mail information fields in the mail heading, and then read in the text field.

Next, in Step S110, the playback software checks an assigned filed data (may be predetermined by a system or decided by a user before use), so as to determine a mail message to be transformed into audio format (wav format, mp3 format, and so forth). One or more than one of the mail information fields may be selected by the user to serve as the assigned filed data. In other words, the selected mail information fields are the fields that the user intends to transform into audio format for playing. For instance, the user may set the text field as the assigned filed data, or further set the first three lines in the text field as the assigned filed data.

Afterward, in Step S115, the playback software extracts a mail message from a corresponding mail information field of the E-mail according to the mail information field recorded in the assigned filed data. For example, if the assigned filed data records the sender field and the receipt date field, the playback software only extracts the mail messages of the sender and the receipt date from the sender field and the receipt date field of the E-mail.

Next, as shown in Step S120, the playback software stores the extracted mail message in a text temporary file. That is, the playback software extracts the mail message from the mail information field which is corresponding to the assigned filed data and stores the mail message in a specific text temporary file. For instance, the text temporary file is created by the playback software for storing the extracted mail messages. It should be noted that the mail messages extracted from the same E-mail are stored in the same text temporary file.

Next, in Step S125, the playback software transforms the text temporary file into an audio data file of audio format via a text-to-speech module. Finally, as shown in Step S130, the playback software plays the audio data file through a sound outputting unit (such as a speaker). What is more, the playback software may continue reading in a second or a third E-mail from the mail transmitting and receiving apparatus while playing the audio data file.

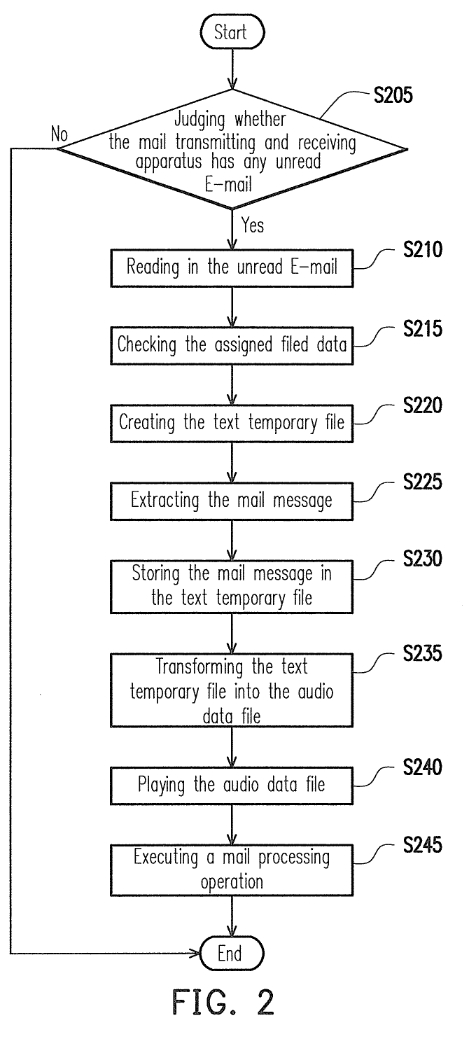

In the following paragraphs, another embodiment is provided for illustrating the steps of playing an E-mail. FIG. 2 is a flow chart illustrating a method for playing E-mail according to another embodiment of the present invention. Referring to FIG. 2, in Step S205, the playback software first judges whether the mail transmitting and receiving apparatus has any unread E-mail. Generally speaking, the user usually checks on the unread E-mails first when opening the mail transmitting and receiving apparatus. Hence, in this embodiment, the playback software is focused on processing the unread E-mails. However, in other embodiments, the playback software is also capable of processing the E-mails that have been read.

Next, as shown in Step S210, if the mail transmitting and receiving apparatus has any E-mail that has not been read, the playback software reads in the first unread E-mail. After that, in Step S215, the playback software starts checking which mail information fields are included in the assigned filed data.

Then, in Step S220, the playback software creates a text temporary file. To be more specific, the playback software may create a plurality of temporary fields in the text temporary file to correspond to all the mail information fields of the E-mail. For example, the sender field corresponds to one temporary field of the text temporary file, and the receipt date field corresponds to another temporary field of the text temporary file.

Moreover, in other embodiments, the text temporary file may be created merely based on the mail information fields included in the assigned filed data. For instance, provided that the assigned filed data only comprises the sender field and the text field. The playback software merely creates two temporary fields, which are corresponding to the sender field and the text field, in the text temporary file for storing the mail messages of the two fields.

Next, Step S225 is the same as Step S115 in the above embodiment, wherein the playback software extracts the mail message from the corresponding mail information field of the E-mail according to the mail information field recorded in the assigned filed data. As shown in Step S230, the playback software stores the mail message in the text temporary file after the mail message are extracted. In other words, the playback software fills the mail message in the corresponding temporary field of the text temporary file. For instance, if the playback software extracts the mail message from the sender field of the E-mail, the mail message is filled in the temporary field, which corresponds to the sender field, of the text temporary file.

Furthermore, for actual application, when the mail message is stored in the text temporary file, the playback software may add relevant information based on the mail information field to which the mail message belongs. For example, the mail message is extracted from the sender field. When the mail message is stored in the corresponding temporary field of the text temporary file, relevant information such as “sender” may be added, such that the E-mail played via audio may has a format similar to the original E-mail.

Then, Step S235 and Step S240 are the same as or similar to Step S125 and Step S130 in the above embodiment. For simplicity, the descriptions thereof are not repeated here. Because the format of the text temporary file is predetermined, the playback software is only required to fill in the extracted mail message. After the text temporary file is transformed into the audio data file for playing, the user is therefore able to receive the complete information about the sender, subject, and so forth of the E-mail.

Finally, as shown in Step S245, the playback software may execute a mail processing operation after playing the audio data file, so as to decide whether to continue playing the audio data file or not. The mail processing operation comprises replaying, deleting a mail, reviewing a previous mail, reviewing a following mail, replying a mail, and forwarding a mail. Additionally, the playback software may receive an audio-control signal to execute the mail processing operation. For example, while the playback software is reading aloud the E-mail, the user may control the playback software by inputting the audio-control signal via voice or clicking on a mouse which is known as the conventional method.

In conclusion, instead of transforming the whole E-mail, the playback software in the above embodiments merely transforms the mail information fields recorded in the assigned filed data into the audio data file. Hence, the time required for the transforming process is reduced. The method for playing E-mail via audio allows the user to listen to E-mails while doing other works. The disadvantage that the user needs to look at the screen for reading E-mails is therefore overcome, and the user's efficiency at work is further improved. What is more, playing E-mail via audio greatly increases the convenience when users who are disabled or have poor vision are reading E-mails.

Although the present invention has been disclosed by the above preferable embodiments, they are not intended to limit the present invention. Anybody with ordinary knowledge in the art may make some modifications and alterations without departing from the spirit and scope of the present invention. Therefore, the scope for which protection is sought by the present invention falls in the appended claims.

What is claimed is:

1. A method for playing E-mail, comprising:
reading in an E-mail from a mail transmitting and receiving apparatus, wherein the E-mail comprises a plurality of mail information fields;
checking an assigned filed data, wherein the assigned filed data records at least one of the mail information fields;
extracting a mail message from a corresponding mail information field of the E-mail according to the mail information field recorded in the assigned filed data;
storing the extracted mail message in a text temporary file;
transforming the text temporary file into an audio data file; and
playing the audio data file.

2. The method for playing E-mail as claimed in claim 1, wherein before the step of storing the extracted mail message in the text temporary file further comprises:
creating the text temporary file.

3. The method for playing E-mail as claimed in claim 2, wherein the step of creating the text temporary file comprises:
creating a plurality of temporary fields in the text temporary file according to the mail information fields of the E-mail, wherein the temporary fields respectively correspond to the mail information fields.

4. The method for playing E-mail as claimed in claim 3, wherein the step of storing the extracted mail message in the text temporary file comprises:
filling the mail message in at least one of the temporary fields corresponding to the text temporary file.

5. The method for playing E-mail as claimed in claim 1, wherein before the step of reading in the E-mail from the mail transmitting and receiving apparatus further comprises:
judging whether the E-mail in the mail transmitting and receiving apparatus has been read or not.

6. The method for playing E-mail as claimed in claim 1, wherein before the step of extracting the mail message from the corresponding mail information field of the E-mail according to the mail information field recorded in the assigned filed data further comprises:
recording at least one of the mail information fields selected by a user in the assigned filed data.

7. The method for playing E-mail as claimed in claim 1, wherein after the step of playing the audio data file further comprises:
executing a mail processing operation to determine whether to continue playing the audio data file.

8. The method for playing E-mail as claimed in claim 7, wherein the mail processing operation comprises one of replaying, deleting a mail, reviewing a previous mail, review a following mail, replying a mail, and forwarding a mail.

9. The method for playing E-mail as claimed in claim 7, wherein the step of executing the mail processing operation further comprises:
receiving an audio-control signal to execute the mail processing operation.

10. The method for playing E-mail as claimed in claim 1, wherein the mail information fields comprise at least one of a sender field, a subject field, a receipt date field, a priority field, and a text field.
